(19) United States
(12) Patent Application Publication
(10) Pub. No.: US 2005/0122674 A1
(43) Pub. Date: Jun. 9, 2005

(54) Multifunction handle for a removable storage or other removable computer devices

(76) Inventors: Thomas Szolyga, Saratoga, CA (US); Laurent Michoux, San Jose, CA (US); Peter Lee, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/732,773

(22) Filed: Dec. 9, 2003

(51) Int. Cl. G06F 1/16

(52) U.S. Cl. 361/685; 361/726; 361/732; 439/345

(57) ABSTRACT

A removable device, such as a removable mass storage device, includes a multifunction handle coupled to the device. The multifunction handle includes a force-developing portion and includes an interlock portion adapted to be engaged by an interlock component. The handle develops an insertion force at the force-developing portion responsive to a force applied to the handle, and also secures the removable device in a desired position to prevent use of the handle responsive to the interlock portion being engaged by the interlock component.

### TECHNICAL FIELD

The present application relates generally to computer systems, and more specifically to removable mass storage or other types of removable devices for computer or other electronic systems.

### BACKGROUND OF THE INVENTION

Modern computer systems include mass storage devices such as hard drives for storing application programs to be executed by the computer system, and for storing data utilized by such programs as well as other data desired to be stored by users of the system. A hard disk is a magnetic disk on which data is stored, and the storage density of a hard disk is the amount of data that can be stored in a given area of the disk. As the storage density of hard drives has increased, meaning that more data can be stored on smaller disks, physically smaller drives having relatively large storage capacities have become possible.

Physically smaller hard drives have led to removable drives, where a removable drive is a hard drive that can easily be plugged into and removed from a drive bay in the computer system. Removable hard drives make it easier to back up data and to transfer data from one computer to another, and also enable a user to more easily replace a defective drive and to upgrade software for the computer system. Furthermore, removable drives provide improved data security in many environments because a removable drive can be removed from the associated computer system and stored in a safe location when desired. Hard drives are the type of removable device being discussed herein merely for ease of description, and one skilled in the art will appreciated that the principles described herein apply equally well to other types of mass storage devices such as magnetic-tape drives, CD-ROM drives, and DVD drives, as well as to other types of removable devices.

Various mechanical configurations for the removable drive and the drive bay into which the drive is inserted are currently utilized. For example, FIG. 1 is an isometric drawing illustrating a portion of a conventional computer system 100 including a removable drive 102 that fits into a drive bay 104. A handle 106 includes pins 108, 110 that fits into respective holes 112, 114 within the drive bay 104 as illustrated by lines 116, 118, and further includes pinion teeth 120 formed near the pins 108, 110. The handle 106 rotates about axes of the pins 108, 110 when inserted into the holes 112, 114. A pair of guide tracks 121 are positioned within the drive bay 104 such that when the removable drive 102 is inserted into the drive bay a pair of guide rails 122 (only one shown in FIG. 1) rest upon the guide tracks. Each of the guide rails 122 includes track teeth 124 formed on the rail near a front end 126 of the removable drive 102. The removable drive 102 further includes a key lock 127 positioned on the front end 126 that controls a rod 129 to either extend through an opening 131 in a side of the removable drive in a direction indicated by an arrow 133 or to retract the rod within the opening. When the removable drive 102 is completely inserted within the drive bay 104, the key lock 127 is activated to cause the rod 129 to extend into a hole (not shown) within the bay to thereby prevent removal of the drive from the bay. In this way, the key lock 127 and rod 129 operate in combination to form an interlock mechanism that prevents removal of the drive 102 from the bay 104 when activated.

In operation, to insert the removable drive 102 into the drive bay 104 the handle 106 is first rotated clockwise about the axis of the pins 108, 110 to position a top cross-member 128 of the handle above an opening of the drive bay. The key lock 127 is deactivated at this point, causing the rod 129 to retract within the opening 131 in the side of the drive. The removable drive 102 is then inserted into the drive bay 104 and the guide rails 122 of the removable drive ride upon the guide tracks 121 within the drive bay. The removable drive 102 is pushed towards a back of the drive bay 104 in a direction indicated by an arrow 130, with the guide rails 122 sliding upon the guide tracks 121 until the track teeth 124 of the guide rails engage the pinion teeth 120 of the handle 106.

At this point, as the removable drive continues to be pushed into the drive bay 104 in the direction indicated by the arrow 130, the handle 106 begins rotating counterclockwise about the axes of the pins 108, 110. A person inserting the removable drive 102 at this point grabs the top cross-member 128 of the handle 106 and applies force to continue the handle rotating counterclockwise and thus towards a bottom of the drive bay 104 in a circular arc. As the handle 106 is rotated counterclockwise, the pinion teeth 120 of the handle engage the track teeth 124, pushing the removable drive 102 towards the back of the drive bay. Electrical connectors (not shown) on a back of the removable drive 102 are coupled to electrical connectors (not shown) at the back of the drive bay 104 as the handle 106 is rotated counterclockwise to electrically interconnect the removable drive to the computer system 100 and thereby complete insertion of the removable drive into the drive bay.

With the removable drive 102 completely inserted into the drive bay 104, the top cross-member 128 of the handle 106 is positioned either across the opening defined by the drive bay 104 adjacent a front end 126 of the removable drive 102 are below the opening defined by the drive bay, depending upon the precise physical structure of the handle. At this point, the key lock 127 is activated causing the rod 129 to extend outward in a direction indicated by the arrow 133 and into the corresponding hole in the side of the drive bay to thereby lock the drive into the bay and prevent removal of the drive.

Once inserted into the drive bay 104, the drive 102 cannot be randomly removed from the bay, or data stored on the disk and other problems with computer system 100 could result, as will be appreciated by those skilled in the art. For example, an operating system running on the computer system 100 may store in cache memory within the computer system some type of file system information structure of the drive 102, such as a file allocation table (FAT) in a Windows system. The file system information structure is a data structure that the operating system uses to locate files on the drive 102, such as the FAT, for example, which corresponds to a table indicating the location of files on the drive. If the drive 102 is pulled out before the current file system information structure stored in cache is transferred to the drive, then the operating system may not know where files are located on the drive and improper operation of the computer system 100 may result (e.g., the system could lock up or crash).

When completely inserted into the drive bay 104 and the key lock 127 activated, a user could grab the top cross-member 128 of the handle and rotate the handle clockwise in an attempt to remove the drive. In this situation, the user could, through the leverage provided by the handle 106, inadvertently break the rod 129 and remove the drive 102. Not only would this break the rod 129 and possibly damage the drive 102, but the drive could be removed at the wrong time, resulting in loss of data on the drive and/or improper operation of the system 100. As a result of the possibility of damaging the drive 102 and rod 129, many drives simply do not include interlock mechanisms such as the key lock 127 and rod 129, leaving open the possibility of removing the drive at the wrong time and losing data.

There is need for a system and method of inserting removable drives into a computer system and preventing removal of such drives at undesirable times.

### SUMMARY OF THE INVENTION

According to one aspect of the present invention, a removable device, such as a removable mass storage device, includes a multifunction handle coupled to the device. The multifunction handle includes a force-developing portion and includes an interlock portion adapted to be engaged by an interlock component. The handle develops an insertion force at the force-developing portion responsive to a force applied to the handle, and also secures the removable device in a desired position to prevent use of the handle responsive to the interlock portion being engaged by the interlock component.

### BRIEF DESCRIPTION OF THE DRAWINGS

FIG. 1 is an isometric drawing illustrating a conventional mechanical structure of a removable disk that fits into a drive bay of a computer system.

FIG. 2 is an isometric drawing of a removable drive including a multifunction handle and interlock mechanism according to one embodiment of the present invention.

FIG. 3 is an isometric drawing showing the multifunction handle of FIG. 2 rotated relative to the position in FIG. 2 and showing insertion cams formed on the handle.

FIG. 4 is an isometric view illustrating the removable drive of FIG. 2 within a cross-section of a drive bay and showing in more detail the interlock mechanism according to one embodiment of the present invention.

FIGS. 5A and 5B are cross-sectional views illustrating the operation of the multifunction handle of FIG. 2 in inserting the removable drive within the drive bay of FIG. 4.

FIG. 6 is a functional block diagram of a computer system including the removable drive and drive bay of FIG. 4 according to one embodiment of the present invention.

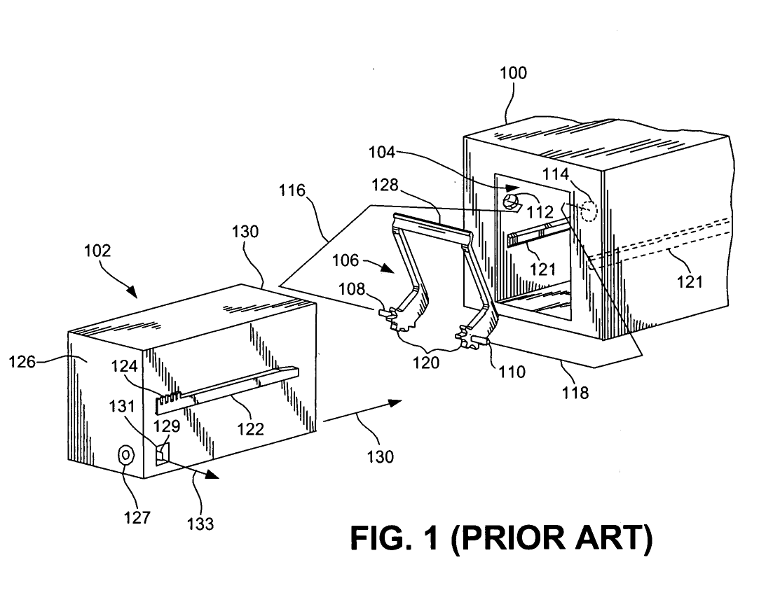

### DETAILED DESCRIPTION OF PREFERRED EMBODIMENTS

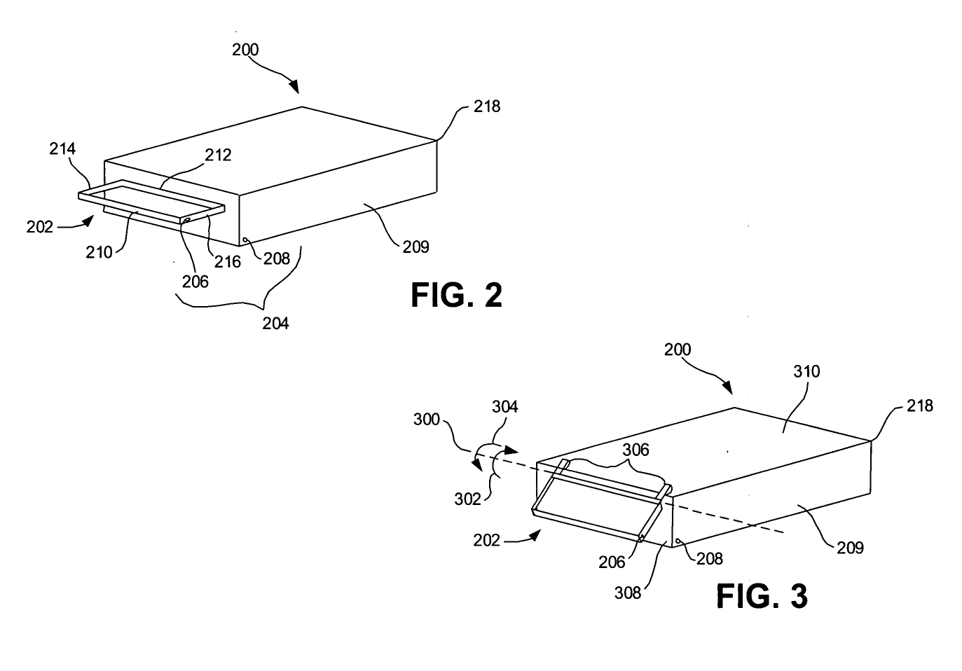

FIG. 2 is an isometric drawing of a removable drive 200 including a multifunction handle 202 and an interlock mechanism 204 according to one embodiment of the present invention. The interlock mechanism 204 includes, in part, an opening 206 in the handle and an opening 208 in a side 209 of the removable drive 200. In operation, the handle 202 functions to assist a user in inserting the removable drive 200 within a drive bay (not shown) and the interlock mechanism 204 functions to prevent the use of the handle and thereby prevent removal of the drive when the interlock mechanism is engaged, as will be described in more detail below. In this way, the handle 202 provides three functions: 1) insertion and removal of the drive 200 into and from a drive bay; 2) interlock to prevent removal of the drive; and 3) carrying handle when the drive is not inserted in a drive bay.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments are within the scope of the present invention. Finally, the operation of well known components or conventional techniques have not been shown or described in detail below to avoid unnecessarily obscuring the present invention.

In the example of FIG. 2, the handle 204 includes a front member 210, a back member 212, a side member 214, and a side member 216 in which the opening 206 is formed. The handle 204 is attached to a housing 218 of the removable drive 200 to rotate about an axis 300 as shown in FIG. 3, which is an isometric drawing showing the multifunction handle 204 rotated relative to the position of the handle in FIG. 2. An arrow 302 indicates the rotation of the handle 204 about the axis 300 in a downward direction and an arrow 304 indicates rotation of the handle in an upward direction. The handle 204 further includes insertion cams 306 extending from the back member 212 that function to apply an insertion force to a drive bay (not shown) into which the drive 200 is being inserted when the front member 210 of the handle is pushed downward, as will be described in more detail below. One skilled in the art will understand that the handle 204 may be mounted to the housing 218 to allow the insertion cams 306 to extend through a front panel 308 and a top panel 310 of the housing in a variety of different ways, and FIGS. 2 and 3 merely functionally illustrate the interconnection between the two.

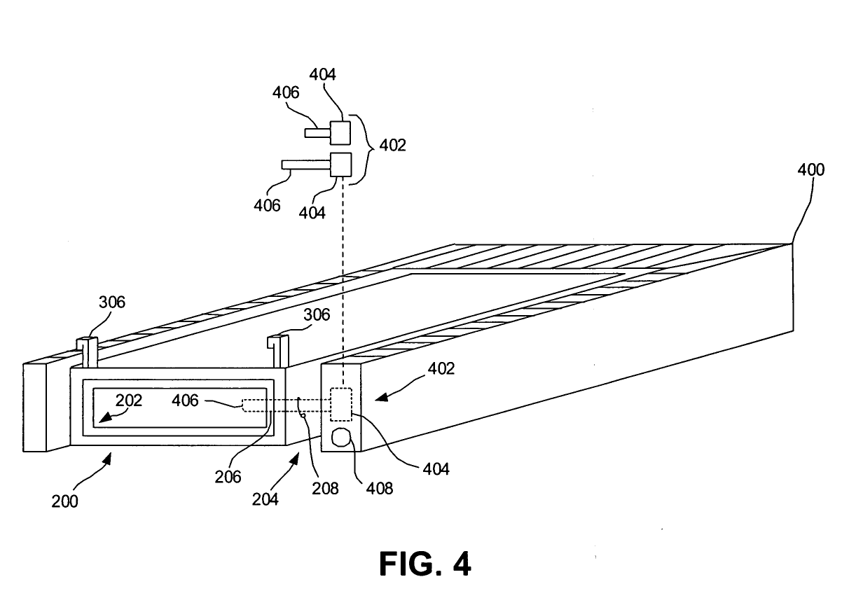

FIG. 4 is an isometric view illustrating the removable drive 200 of FIG. 2 within a cross-section of a drive bay 400 and showing in more detail the interlock mechanism 204 according to one embodiment of the present invention. The interlock mechanism 204 includes a solenoid 402 having a base 404 and a rod 406, with the base being positioned so that the rod extends and retracts through the hole 208 (FIG. 3) and through the hole 206 in the handle 202. The interlock mechanism 402 is also shown above the drive bay 400 and removable drive 200 to better illustrate the operation of the mechanism. The upper depiction of the interlock mechanism 402 shows the rod 206 in a retracted position to withdraw the rod from the holes 206, 208, such as during insertion and removal of the drive 200 from the drive bay 400. Conversely, the lower diagram shows the rod 206 in an extended position to insert the rod into the holes 206, 208 and thereby prevent use of the handle 202 and removal of the drive 200 from the bay 400. When the drive 200 is fully inserted into the drive bay 200 to couple electronics (not shown) of the drive to electronics (not shown) in the drive bay, the handle 202 is positioned downward as shown with the hole 206 in a position to receive the rod 406.

A release switch 408 is positioned on a front edge of the drive bay 400 and is electrically coupled to electronics (not shown) in the drive bay. When the switch 408 is activated by a user, electronics within a computer system (not shown), of which the drive bay is a part, place the removable drive 200 into a condition safe for removal and communicate with the interlock mechanism 402 to withdraw the rod 402 and thereby allow the user to remove the drive using the handle 202, as will be discussed in more detail below.

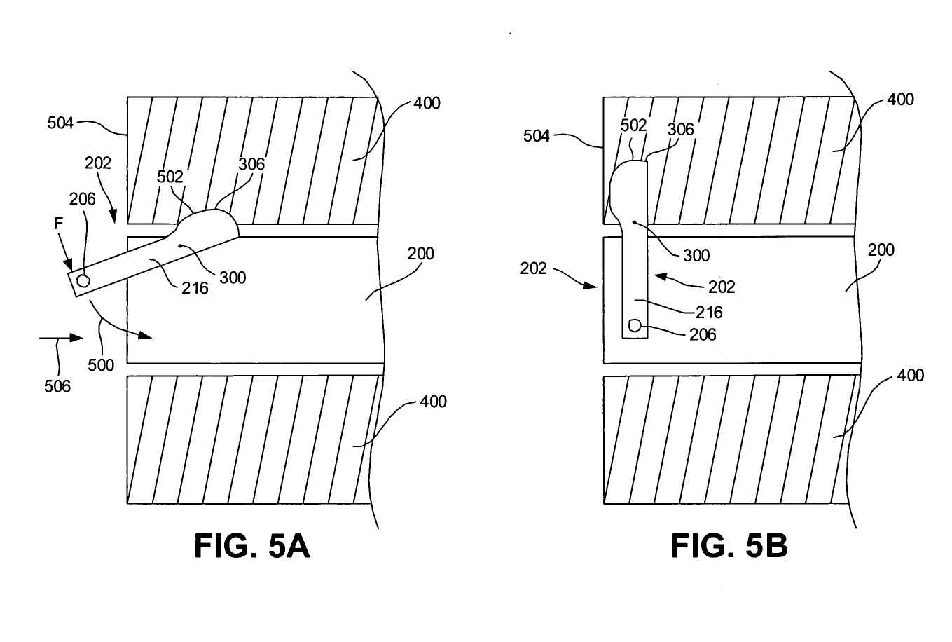

FIGS. 5A and 5B are cross-sectional views illustrating the operation of the multifunction handle 202 of FIG. 2 in inserting the removable drive 200 within the drive bay of FIG. 4. In FIG. 5A, a force F is applied to the handle 202 to rotate the handle downward (i.e., counterclockwise) about the axis 300 as indicated by arrow 500. As the handle 202 is rotated downward, a front portion 502 of the insertion cam 306 contacts an inner front portion 504 of the drive bay 400, pushing the removable drive 200 into the drive bay as indicated by arrow 506. FIG. 5B shows the handle rotated fully downward, with the force F of the front portion 502 of insertion cam 306 pushing the drive 200 into its fully inserted position within the drive bay 400. At this point in FIG. 5B, the side member 216 of handle 212 is positioned vertically with the hole 206 positioned to receive the rod 406 (not shown) of the interlock mechanism 402. Once the rod 406 extends through the hole 206, the handle 202 is secured in the position shown in FIG. 5B and may not be used to remove the drive 200 from the bay 400.

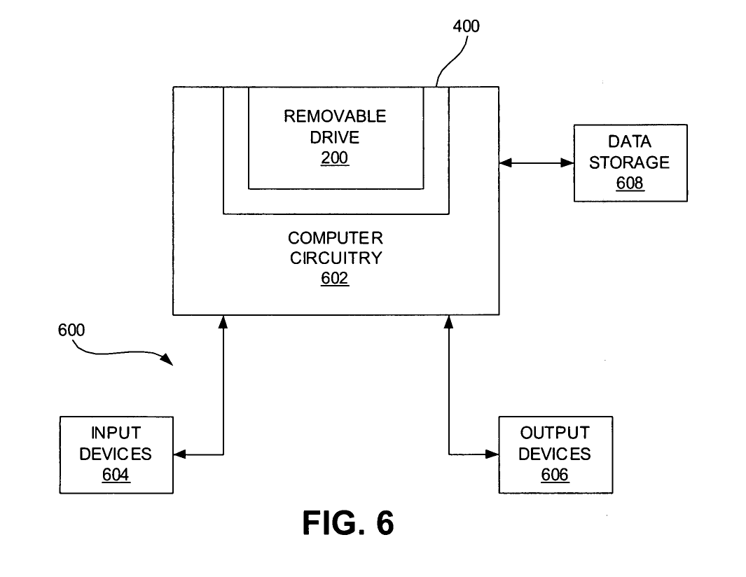

FIG. 6 is a functional block diagram of a computer system 600 including the removable drive 200 and drive bay 400 of FIG. 4 according to one embodiment of the present invention. The removable drive 200 is coupled through the drive bay 400 to computer circuitry 602 to provide for writing data to and reading data from the removable drive, and also for controlling the interlock mechanism 402 (FIG. 4), as will be described in more detail below. The computer circuitry 602 also includes memory, such as dynamic random access memory (DRAM), and includes circuitry and operating system software for performing various computing functions, such as executing specific application software to perform specific calculations or tasks. Although the computer system 600 is shown as including only one removable drive 200 and associated drive bay 400, a plurality of removable drives and associated drive bays may be included in the computer system 600.

The computer system 600 further includes one or more input devices 604, such as a keyboard or a mouse, coupled to the computer circuitry 602 to allow an operator to interface with the computer system. Typically, the computer system 600 also includes one or more output devices 606 coupled to the computer circuitry 602, such as a printer and a video terminal. One or more data storage devices 608 are also typically coupled to the computer circuitry 602 to store data or retrieve data from external storage media (not shown). Examples of typical storage devices 908 could include floppy disks, tape cassettes, compact disk read-only (CD-ROMs) and compact disk read-write (CD-RW) memories, digital video disks (DVDs), and permanently installed hard drives.

The overall process of the insertion and removal of the removable drive 200 into and from the computer system 600 will now be described in more detail with reference to FIGS. 2-6. Assume the drive 200 is initially not inserted into the drive bay 400. In this situation, the rod 406 of the interlock mechanism 402 is in the retracted position. A user then inserts the removable drive 200 into the drive bay 200 and pushes the drive toward the back of the bay, using the handle 202 and/or pushing on the front panel 308 of the drive. Once the drive 200 is nearly fully inserted into the drive bay 400, roughly in the position shown in FIG. 5B, the handle 202 is rotated downward. As the handle 202 is rotated downward, insertion cams 306 push against the inner front portion 504 of the drive bay 400, pushing the drive 200 fully into position within the drive bay and thereby coupling electrical connectors (not shown) on a back of the removable drive 200 to electrical connectors (not shown) at the back of the drive bay 400.

At this point, the handle 202 is rotated fully downward as shown in FIGS. 4 and 5B. The computer circuitry 602 detects that the drive 200 has been inserted into the drive bay 400, and activates the interlock mechanism 402 to extend the rod 406 through the holes 206, 208 and secure the drive within the bay. The removable drive 200 is in this way coupled to the computer system 600, and cannot be inadvertently removed by a user. For example, if an operating system running on the computer system 600 stores a file system information structure of the drive 200 in cache memory within the computer circuitry 602, the drive cannot simply be pulled out of the bay 400 without the operating system having updated the file system information structure stored on the drive.

The removal of the drive 200 may then occur in at least two different ways. First, the release switch 408 may be activated by a user wishing to remove the drive 200 from the computer system 200. In response to the switch 408 being activated, the operating system or other suitable program in the computer circuitry 602 first updates the file system information structure on the drive using the file system information structure stored in cache memory, if necessary. The operating system or other program thereafter deactivates the interlock mechanism 402, causing the rod 406 to withdraw from the holes 206, 208. Once the rod 406 is withdrawn from the holes 206, 208, a user rotates the handle upward, disengaging the insertion cams 306 and the inner front portions 504 of the drive bay 400 and allowing the user to pull the drive out of the bay. Another way the drive 200 could be removed is for a user to select through a “soft switch” on display of the computer system 600 the desire to remove the drive from the system. In response to this selection, the operating system or other program would then deactivate the interlock mechanism 402 and a user would remove the drive from the bay 400 in the same way as just described.

Although the removable drive 200 is described as being a removable mass storage device, the removable drive could be another type of removable device as well. Also, although the handle 202 is shown and described as having a specific structure, one skilled in the art will realize that the handle may assume a variety of alternative and equivalent structures. For example, although the handle 202 is shown as rotating in an upward and downward direction in the described embodiments, in other embodiments the handle could function in a side-to-side manner to perform the same insertion and interlock functions in conjunction with the interlock mechanism 404. The handle 202 may be formed from a variety of structures suitable for performing the desired insertion and interlock functions. Similarly, the interlocking mechanism 402 may be a variety of different structures, with the specific structure of the interlocking mechanism being selected to perform the desired function in conjunction with the particular handle 202 structure being utilized. Such alternative and equivalent structures for the handle 202 and interlocking mechanism 402 will be understood by those skilled in the art, and should be considered aspects of the present invention.

Even though various embodiments of the present invention have been set forth in the foregoing description, the above disclosure is illustrative only, and changes may be made in detail and yet remain within the broad principles of the present invention. One skilled in the art will appreciate that the example embodiments described above do not limit the scope of the present invention, and will also understand various modifications, equivalents, and combinations of such embodiments are within the scope of the present invention. Therefore, the present invention is to be limited only by the appended claims.

1. A removable device including a multifunction handle coupled to the device, the multifunction handle including a force-developing portion and including an interlock portion adapted to be engaged by an interlock component, the handle operable to develop an insertion force at the force-developing portion responsive to a force applied to the handle and operable to secure the removable device in a desired position and prevent use of the handle responsive to the interlock portion being engaged by the interlock component.

2. The removable device of claim 1 wherein the force-developing portion comprises a cam.

3. The removable device of claim 1 wherein the interlock portion comprises an aperture in the handle and an aperture in a side of the removable device, and wherein the interlock component comprises a rod adapted to extend through the two apertures.

4. The removable device of claim 3 wherein the removable device comprises a removable mass storage device.

5. The removable device of claim 1 wherein the removable drive has a top panel, bottom panel, and two side panels, and wherein the multifunction handle rotates in an upward and a downward direction about an axis that is parallel to the top and bottom panels.

6. The removable device of claim 1 wherein the removable drive has a top panel, bottom panel, and two side panels, and wherein the multifunction handle develops the insertion force responsive to a sideways force applied leftward or rightward to the handle.

7. The removable device of claim 1 wherein the handle comprises:
a front member;
a back member;
a first side member having a first end coupled to the front member and a second end coupled to the back member;
a second side member having a first end coupled to the front member and a second end coupled to the back member, and including an aperture corresponding to the interlock portion; and
at least one insertion cam extending from the back member.

8. A computer system, comprising:
computer circuitry;
at least one drive bay, each drive bay being electrically coupled to the computer circuitry, and each drive bay including,
an interlock mechanism, and
a release switch; and
at least one removable device, each removable device being adapted to be positioned in a drive bay and including a multifunction handle having an interlock portion, the handle developing an insertion force responsive to a force applied to the handle to assist in inserting the device into the bay, and the interlock mechanism operable to engage the interlock portion responsive to an activation signal from the computer circuitry, and the interlock mechanism operable to disengage the interlock portion responsive to a deactivation signal from the computer circuitry developed responsive to the release switch being activated.

9. The computer system of claim 8 wherein each handle includes a cam that functions as a force-developing portion to develop the insertion force.

10. The computer system of claim 8 wherein each interlock portion comprises and aperture formed in the handle.

11. The computer system of claim 8 further comprising:
at least one input device coupled to the computer circuitry;
at least one data output device coupled to the computer circuitry; and
at least one permanent data storage device.

12. The computer system of claim 8 wherein the interlock mechanism comprises a solenoid.

13. The computer system of claim 8 wherein the removable device comprises a removable mass storage device.

14. The computer system of claim 8 wherein the removable drive has a top panel, bottom panel, and two side panels, and wherein the multifunction handle rotates in an upward and a downward direction about an axis that is parallel to the top and bottom panels.

15. The computer system of claim 8 wherein the removable drive has a top panel, bottom panel, and two side panels, and wherein the multifunction handle develops the insertion force responsive to a sideways force applied leftward or rightward to the handle.

16. The computer system of claim 8 wherein release switch comprises a switch positioned adjacent an opening of each drive bay.

17. A multifunction handle adapted to be coupled to a removable device, the multifunction handle including a force-developing portion and including an interlock portion adapted to be engaged by an interlock component, the handle operable to develop an insertion force at the force-developing portion responsive to a force applied to the handle and operable to be secured in a fixed position responsive to the interlock portion being engaged by the interlock component.

18. The multifunction handle of claim 17 wherein the force-developing portion comprises a cam.

19. The multifunction handle of claim 17 wherein the interlock portion comprises an aperture.

20. The multifunction handle of claim 17 comprising:
a front member;
a back member;
a first side member having a first end coupled to the front member and a second end coupled to the back member;
a second side member having a first end coupled to the front member and a second end coupled to the back member, and including an aperture corresponding to the interlock portion; and
at least one insertion cam extending from the back member.

21. A method of inserting a removable drive into a drive bay of a computer system, the removable drive including a handle and the method comprising:
applying a force to the handle to insert the drive into the drive bay;
detecting the insertion of the drive into the drive bay;
disabling use of the handle and securing the drive in the drive bay responsive to the detecting the insertion of the drive into the drive bay;
detecting activation of a release mechanism; and
enabling use of the handle responsive to detecting activation of the release mechanism.

22. The method of claim 21 wherein detecting activation of a release mechanism comprising detecting an activation of a switch.

23. The method of claim 22 wherein detecting an activation of a switch comprises detecting selection of a soft switch displayed by the computer system.

24. The method of claim 21 further comprises updating information stored on the removable drive after detecting activation of a release mechanism and before enabling use of the handle.

25. The method of claim 21 wherein disabling use of the handle comprises inserting a rod through an aperture in the handle.
